(19) United States
(12) Patent Application Publication
(10) Pub. No.: US 2012/0278888 A1
(43) Pub. Date: Nov. 1, 2012

(54) GATEWAY AND METHOD FOR AVOIDING ATTACKS

(75) Inventors: TSE-HSIEN LIN, Tu-Cheng (TW); CHI-WEN CHENG, Tu-Cheng (TW)

(73) Assignee: HON HAI PRECISION INDUSTRY CO., LTD., Tu-Cheng (TW)

(21) Appl. No.: 13/433,312

(22) Filed: Mar. 29, 2012

(30) Foreign Application Priority Data
Apr. 26, 2011 (CN) 201110105115.3

(51) Int. Cl. G06F 21/00

(52) U.S. Cl. 726/23

(57) ABSTRACT

A gateway assigns an IP address included in an address list to a client in a local area network (LAN). The gateway inquires whether the assigned IP address is used by other clients in the LAN. The gateway records a media access control (MAC) address of the client and the assigned IP address in a mapping table when the assigned IP address is not used by the other clients in the LAN. The gateway transmits an address resolution protocol (ARP) request packet to the client, and determines whether an ARP response packet is received from the client. The gateway can determine that the client is an attacker if no ARP response packet is received from the client.

### BACKGROUND

1. Technical Field

Embodiments of the present disclosure generally relate to network communications, and more particularly to a gateway and a method for avoiding network attacks.

2. Description of Related Art

A gateway is a device that is equipped for interfacing with another network that uses different protocols.

Many gateways have a dynamic host configuration protocol (DHCP) module. DHCP is a network configuration protocol for hosts on the Internet protocol (IP) networks. Clients that are connected to IP networks must be configured before they can communicate with other hosts. When DHCP clients want to connect IP networks, they send address request packets to a DHCP module. The address request packets include media access control (MAC) addresses of the clients. The DHCP module receives the address request packets and assigns an IP address to each DHCP client. The DHCP client gains access to the Internet by using the assigned IP address.

Sometimes, malicious clients change their MAC addresses in address request packets continuously. The DHCP module receives the address request packets and assigns IP addresses to the clients according to the address request packets. The available IP addresses stored in the DHCP module are exhausted quickly, which reduces the quality of normal communications.

It is urgent to provide a safe gateway and a method for avoiding attacks.

### BRIEF DESCRIPTION OF THE DRAWINGS

FIG. 1 is a schematic diagram of an application environment of one embodiment of a gateway in accordance with the present disclosure.

FIG. 2 is a block diagram of functional modules of the gateway in FIG. 1.

FIG. 3 is a schematic diagram of one embodiment of a mapping table of the gateway in accordance with the present disclosure.

FIG. 4 is a flowchart of one embodiment of a method for avoiding attacks in the gateway.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

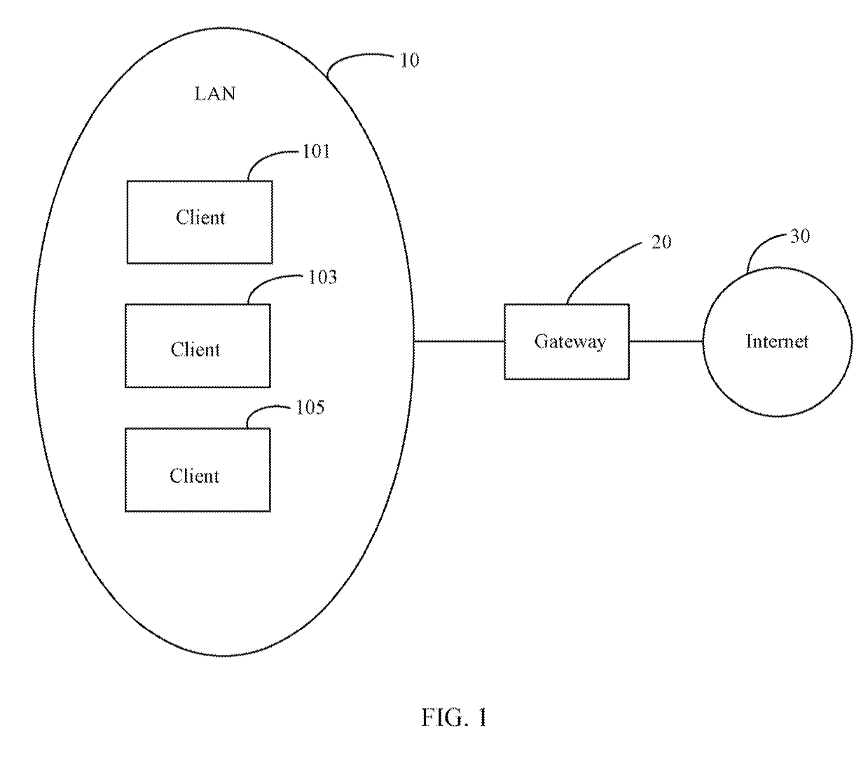

FIG. 1 is a schematic diagram of an application environment of one embodiment of a gateway 20 in accordance with the present disclosure. In one embodiment, the gateway 20 is electronically connected to a plurality of clients, such as clients 101, 103 and 105 in a local area network (LAN) 10. In the present embodiment, the plurality of clients may be dynamic host configuration protocol (DHCP) clients, personal computers (PCs), personal digital assistants (PDAs), and mobile phones, for example. In one embodiment, the gateway 20 may wirelessly communicate with the plurality of clients, or may communicate with the plurality of clients by a wired connection. Similarly, the gateway 20 may be connected to the Internet 30 wirelessly or by a physical connection.

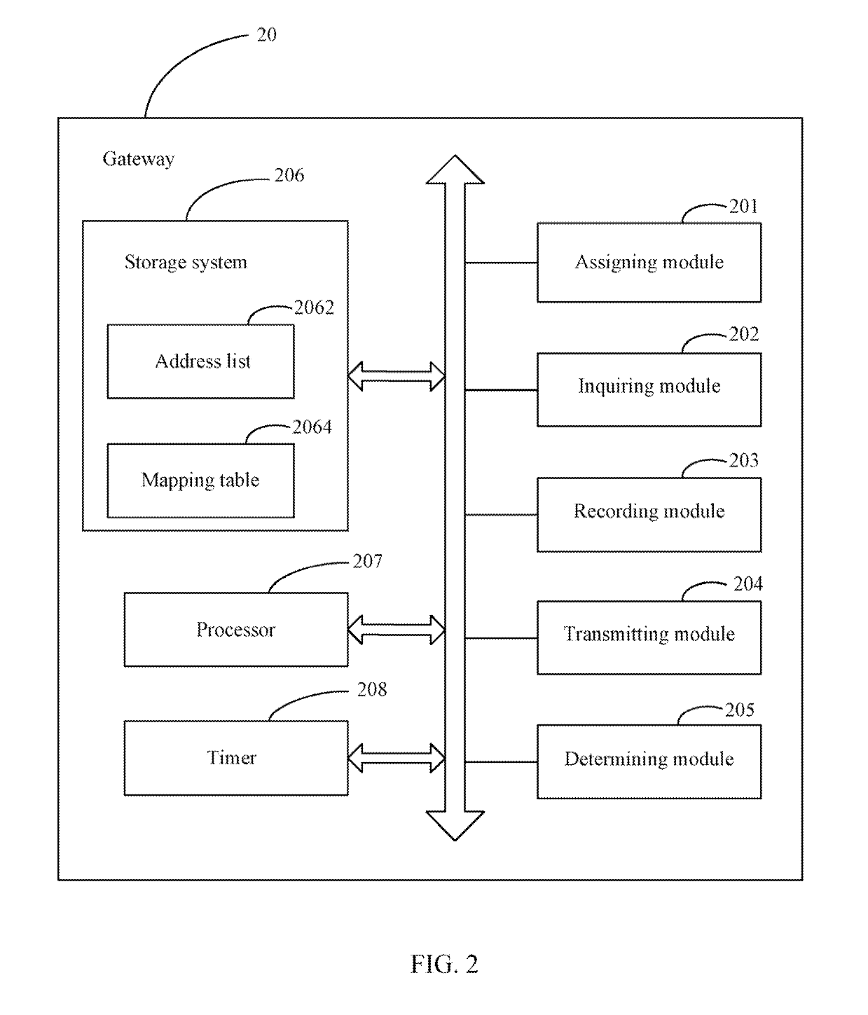

FIG. 2 is a block diagram of functional modules of the gateway 20 in FIG. 1. In the present embodiment, the gateway 20 includes an assigning module 201, an inquiring module 202, a recording module 203, a transmitting module 204, a determining module 205, a storage system 206, at least one processor 207, and a timer 208. The modules 201-205 may comprise computerized code in the form of one or more programs that are stored in the storage system 206. The computerized code includes instructions that are executed by the at least one processor 207 to provide functions for the modules 201-205. In one example, the storage system 206 may include a hard disk drive, a flash memory, a cache or another computerized memory device.

In this embodiment, the storage system 206 stores an address list 2062 and a mapping table 2064. The address list 2062 records a plurality of the Internet protocol (IP) addresses that can be provided to the plurality of clients in the LAN 10. The plurality clients connect to the Internet 30 using the IP addresses.

In the present embodiment, when the client 101 logins the LAN 10 for the first time, the client 101 has no IP address and broadcasts a DHCP discovery packet in the LAN 10 to find a network device capable of assigning an IP address, such as the gateway 20. The DHCP discovery packet comprises a media access control (MAC) address of the client 101. The assigning module 201 receives the DHCP discovery packet and determines whether an IP address is available for use in the address list 2062 at the present moment. The assigning module 201 transmits a DHCP offer packet to the client 101 upon the condition that an IP address is available for use in the address list 2062. The DHCP offer packet comprises a MAC address of the gateway 20 and an IP address assigned to the client 101.

In the present embodiment, at least one network device can assign an IP address to the client 101. When the at least one network device receives the DHCP discovery packet from the client 101, the at least one network device transmits at least one DHCP offer packet to the client 101. In this situation, the client 101 may receive the at least one DHCP offer packet, and selects the earliest received DHCP offer packet. In the present embodiment, the earliest received DHCP offer packet comes from the gateway 20, for example.

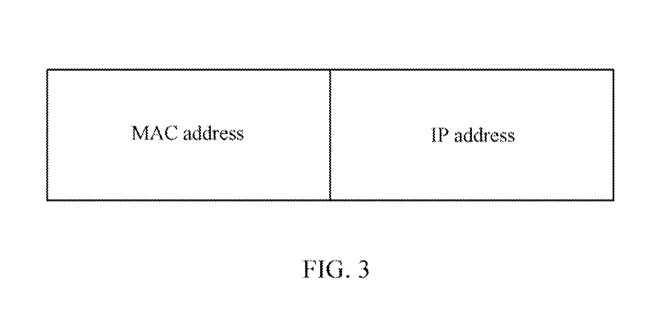

In the present embodiment, when the client 101 receives the DHCP offer packet from the gateway 20, the client 101 broadcasts a DHCP request packet in the LAN 10. The DHCP request packet is used to state only that the client 101 receives an IP address assigned by the gateway 20. When the assigning module 201 receives the DHCP request packet from the client 101, the gateway 20 is entitled to assign an IP address to the client 101. The inquiring module 202 transmits a first address resolution protocol (ARP) request packet to the other clients in the LAN 10, to inquire whether the assigned IP address has been used by the other clients in the LAN 10. If the assigned IP address is not being used by the other clients in the LAN 10, the inquiring module 202 transmits a DHCP acknowledge (ACK) packet to the client 101 according to the MAC address of the client 101 to make sure that the assigned IP address is assigned to the client 101. In the meantime, the recording module 203 records the MAC address of the client 101 and the assigned IP address in the mapping table 2064. Referring to FIG. 3, the relation between a MAC address and an assigned IP address in the mapping table 2064 is a one-to-one correspondence.

Referring to FIG. 2, when the recording module 203 has recorded the MAC address of the client 101 and the assigned IP address together in the mapping table 2064, the recording module 203 stores the mapping table 2064 in the storage system 206 and transmits a second DHCP ACK packet to the client 101. When the recording module 203 transmits the second DHCP ACK packet to the client 101, the timer 208 starts to time according to a timing period T1.

When the client 101 receives the second DHCP ACK packet from the gateway 20, the timer 208 starts to time according to a timing period T2. When the timing period T2 is reached, the client 101 broadcasts a DHCP gratuitous packet in the LAN 10 to determine whether the assigned IP address has been used by the other network devices in the LAN 10, and then the timer 208 starts to time according to a timing period T3. When the timing period T3 is reached and no response packet is received from the other network devices in the LAN 10, it means that the assigned IP address can be used by the client 101.

In the present embodiment, the timer 208 starts to time according to a timing period T2 when the client 101 receives the second DHCP ACK packet from the gateway 20, and the timer 208 starts to time according to a timing period T3 when the client 101 broadcasts the DHCP gratuitous packet in the LAN 10. The timer 208 informs the client 101 of the timing period T2 and the timing period T3 by transmitting a DHCP gratuitous packet to the client 101. The value of the timing period T1 is the maximum between the timing period T2 and the timing period T3 plus an experiential value, and the value of the timing period T1 is bigger than the timing period T2 or the timing period T3. In the present embodiment, the experiential value may be 50 milliseconds (ms) and is not limited in other embodiments.

When the timing period T1 is reached, the transmitting module 204 transmits the second ARP request packet to the client 101 and determines whether an ARP response packet is received from the client 101. In the present embodiment, the destination MAC address in the second ARP request packet is the MAC address of the client 101.

For an attacker who attacks a gateway by changing the MAC address of the attacker continually and transmitting an address request packet comprising the MAC address of the attacker to network devices capable of assigning an IP address, the attacker will receive a lot of IP addresses from the network devices.

Taking into consideration of the above-mentioned method of the attack, if the gateway 20 does not receive the ARP response packet from the client 101, the determining module 205 determines that the MAC address has been changed and the client 101 is questionable entity such as an attacker. The gateway 20 stops assigning the assigned IP address to the client 101.

If the gateway 20 receives the ARP response packet from the client 101, the determining module 205 determines whether the MAC address in the ARP response packet exists in the mapping table 2064. If the MAC address exists in the mapping table 2064, the determining module 205 determines that the client 101 is not a questionable entity. If the MAC address does not exist in the mapping table 2064, the determining module 205 determines that the client 101 is a questionable entity and the gateway 20 stops assigning the assigned IP address to the client 101.

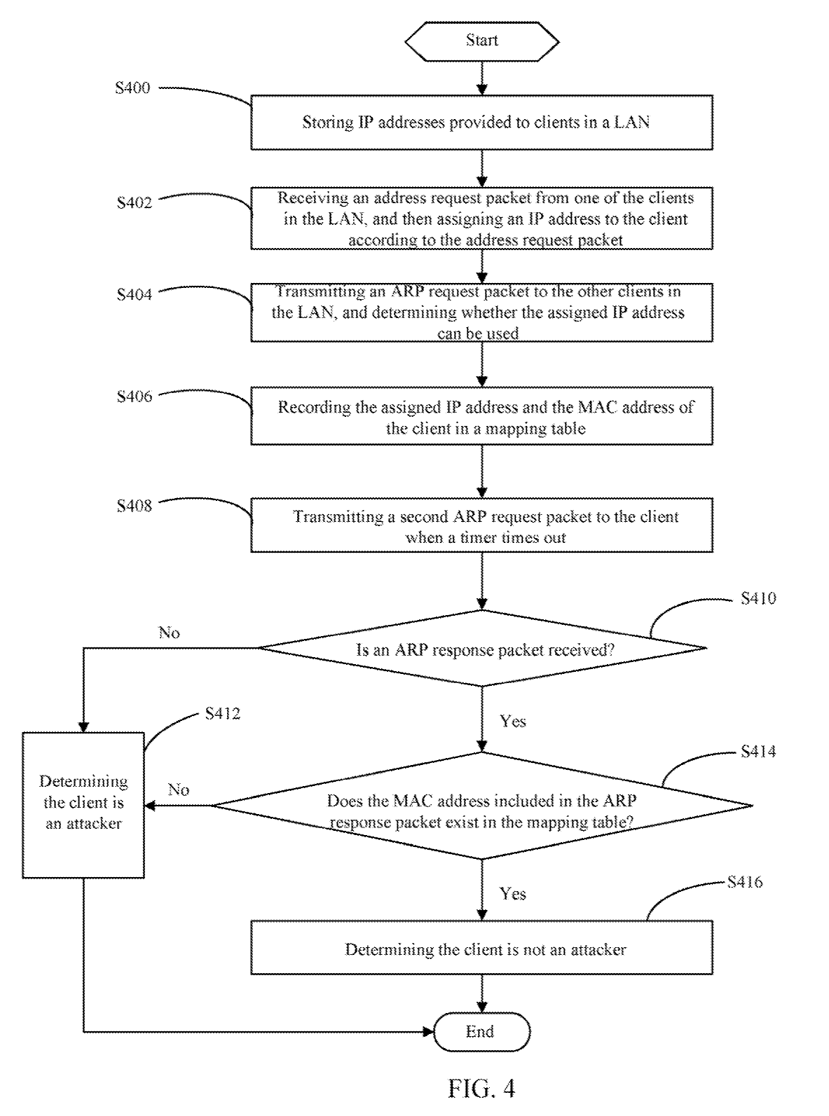

Referring to FIG. 4, this is a flowchart of one embodiment of a method for avoiding an attack in the gateway 20. In one embodiment, the method functions by the modules in FIG. 2 in the manner following.

In block S400, the address list 2062 records a plurality of Internet protocol (IP) addresses for the plurality of clients in the LAN 10. Each client connects to the Internet 30 by using an IP address.

In block S402, the assigning module 201 receives an address request packet from the client 101 and assigns an IP address to the client 101 according to the address request packet. In the present embodiment, the assigning module 201 receives a dynamic host configuration protocol (DHCP) discovery packet from the client 101 and determines whether an IP address is available in the address list 2062 in the present. The assigning module 201 transmits a DHCP offer packet to the client 101 upon the condition that an IP address is available in the address list 2062. The DHCP offer packet comprises a MAC address of the gateway 20 and an IP address assigned to the client 101.

In the present embodiment, at least one network devices can provide an IP address to the client 101. When the at least one network device receives the DHCP discovery packet from the client 101, the at least one network device transmits at least one DHCP offer packet to the client 101. In this situation, the client 101 may receive the at least one DHCP offer packet, and selects the earliest received DHCP offer packet. In the present embodiment, the earliest received DHCP offer packet comes from the gateway 20, for example.

In the present embodiment, when the client 101 receives the DHCP offer packet from the gateway 20, the client 101 broadcasts a DHCP request packet in the LAN 10. The DHCP request packets are used to state only that the client 101 receives an IP address assigned by the gateway 20. When the assigning module 201 receives the DHCP request packet from the client 101, the gateway 20 is entitled to assign an IP address to the client 101.

In block S404, the inquiring module 202 transmits a first Address Resolution Protocol (ARP) request packets to the other clients in the LAN 10, such as client 103, client 105 and so forth, so as to inquire whether an IP address to be assigned is used by the other clients in the LAN 10. If the IP address to be assigned has not been used by the other clients in the LAN 10, the inquiring module 202 transmits a DHCP acknowledge (ACK) packet to the client 101 according to the MAC address of the client 101 to make sure that the assigned IP address is assigned to the client 101.

In block S406, the recording module 203 records the MAC address of the client 101 and the assigned IP address in the mapping table 2064, and then the recording module 203 transmits a second DHCP ACK packet to the client 101. When the recording module 203 transmits a second DHCP ACK packet to the client 101, the timer 208 starts to time according to a timing period T1.

In the present embodiment, when the client 101 receives the second DHCP ACK packet from the gateway 20, the timer 208 starts to time according to a timing period T2. When the timing period T2 is reached, the client 101 broadcasts a DHCP gratuitous packet in the LAN 10 to determine whether the assigned IP address has been used by the other network devices, and the timer 208 starts to time according to a timing period T3. When the timing period T3 is reached and no response packet is received from other network devices, it means that the assigned IP address can be used by the client 101.

In the present embodiment, the timer 208 starts to time according to a timing period T2 when the client 101 receives the second DHCP ACK packet from gateway 20, and the timer 208 starts to time according to a timing period T3 when the client 101 broadcasts the DHCP gratuitous packet in the LAN 10. The timer 208 informs the client 101 of the timing period T2 and timing period T3 by transmitting a DHCP gratuitous packet to the client 101. The value of the timing period T1 is the maximum between the timing period T2 and the timing period T3 plus an experiential value, and the value of the timing period T1 is bigger than the timing period T2 or the timing period T3. In the present embodiment, the experiential value may be 50 ms and is not limited in other embodiments.

In block S408, when the timing period T1 is reached, the transmitting module 204 transmits the second ARP request packet to the client 101.

In block S410, the transmitting module 204 determines whether an ARP response packet has been received from the client 101. In the present embodiment, the destination MAC address in the second ARP request packet is the MAC address of the client 101.

For an attacker attacking a gateway by changing the MAC address of the attacker continually and transmitting an address request packet comprising the MAC address of the attacker to network devices capable of providing an IP address, he will receive a lot of IP addresses from the network devices.

Taking into consideration of the above-mentioned method of the attack, if the gateway 20 does not receive the ARP response packet from the client 101, block 5412 is implemented and the determining module 205 determines that the MAC address has been changed and the client 101 is a questionable entity such as an attacker. Otherwise, block S414 is implemented and the determining module 205 determines whether the MAC address included in the ARP response packet exists in the mapping table 2064. If the MAC address exists in the mapping table 2064, block 5416 is implemented and the determining module 205 determines that the client 101 is not a questionable entity. Otherwise, block 5412 is implemented and the determining module 205 determines that the client 101 is a questionable entity such as an attacker. In the present embodiment, if the client 101 is an attacker, the gateway 20 stops assigning the assigned IP address to the client.

In the embodiments of the method and the gateway for protection against network attacks, the gateway 20 transmits the second ARP request packet to the client 101 and determines the client 101 is an attacker upon the condition that the gateway 20 does not receive an ARP response packet from the client 101. If the client 101 is an attacker, the gateway 20 stops assigning the assigned IP address to the client 101. The method and the gateway greatly improve the service quality of communication by preventing a “denial of service” situation arising through malice, to the detriment of other valid clients.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A gateway electronically connected to a plurality of clients in a local area network (LAN), comprising:
at least one processor;
a storage system storing an address list that records a plurality of protocol (IP) addresses for the plurality of clients in the LAN;
one or more programs that are stored in the storage system and are executed by the at least one processor, the one or more programs comprising:
an assigning module receiving an address request packet from one of the plurality of clients in the LAN, and assigning an IP address recorded in the address list to the one client according to the address request packet;
an inquiring module transmitting a first address resolution protocol (ARP) request packet to the plurality of clients except the one client in the LAN, and inquiring whether the assigned IP address has been used by the plurality of clients except the one client;
a recording module recording a media access control (MAC) address of the one client and the assigned IP address in a mapping table upon the condition that the assigned IP address has been used by the plurality of clients except the one client, and starting a timer;
a transmitting module transmitting a second ARP request packet to the one client when the timer times out, and determining whether an ARP response packet is received from the one client; and
a determining module determining that the one client is an attacker upon the condition that no ARP response packet is received from the one client, and stopping assigning the assigned IP address to the one client.

2. The gateway as claimed in claim 1, wherein the determining module determines whether a MAC address in the APR response packet exists in the mapping table upon the condition that the determining module have received the ARP response packet from the one client.

3. The gateway as claimed in claim 2, wherein the determining module determines that the one client is not an attacker upon the condition that the MAC address in the ARP response packet exists in the mapping table.

4. The gateway as claimed in claim 2, wherein the determining module determines that the one client is an attacker and stop assigning the assigned IP address to the one client upon the condition that the MAC address in the ARP response packet does not exist in the mapping table.

5. A method for avoiding attacks in a gateway, the gateway connecting to a plurality of clients in a local area network (LAN), the method comprising:
providing a storage system storing an address list that records a plurality of Internet protocol (IP) addresses for the plurality of clients in the LAN;
receiving an address request packet from one of the plurality of clients in the LAN, and assigning an IP address recorded in the address list to the one client according to the address request packet;
transmitting a first address resolution protocol (ARP) request packet to the plurality of clients except the one client in the LAN, and inquiring whether the assigned IP address has been used by the plurality of clients except the one client;
recording the assigned IP address and a media access control (MAC) address of the one client in a mapping table upon the condition that the assigned IP address has been used by the plurality of clients except the one client, and starting a timer;
transmitting a second ARP request packet to the one client when the timer times out, and determining whether an ARP response packet is received from the one client; and
determining that the one client is an attacker upon the condition that no ARP response packet is received from the one client, and stopping assigning the assigned IP address to the one client.

6. The method as claimed in claim 5, further comprising:
determining whether a MAC address in the ARP response packet exists in the mapping table upon the condition that the ARP response packet is received from the one client.

7. The method as claimed in claim 6, further comprising:
determining that the one client is not an attacker upon the condition that the MAC address in the ARP response packet exists in the mapping table.

8. The method as claimed in claim 6, further comprising:
determining that the one client is an attacker and stopping assigning the assigned IP address to the client upon the condition that the MAC address in the ARP response packet does not exist in the mapping table.
